(19) United States
(12) Patent Application Publication
(10) Pub. No.: US 2010/0053546 A1
(43) Pub. Date: Mar. 4, 2010

(54) EYEGLASSES

(75) Inventor: ALESSANDRO LANARO, New York, NY (US)

Correspondence Address: Steven B. Kelber;Berenato, White & Stavish, 6550 Rock Spring Drive, Suite 240, Bethesda, MD, 20817, US

(73) Assignee: TWOROGER ASSOCIATES, LTD., DBA., MODO EYEWEAR, NEW YORK, NY (US)

(21) Appl. No.: 12/200,092

(22) Filed: Aug. 28, 2008

(51) Int. Cl. G02C 5/16

(52) U.S. Cl. 351/114

(57) ABSTRACT

Eyeglasses are provided with temples that are constructed of a metal, preferably a memory alloy like beta alumina. The temples exhibit corrugations, or folds, along the the temple, at a point proximal to the pivot pin of the hinge where the temples are secured to the frame. The corrugations may be in any direction, including the longitudinal axis of the temple. The temples, due to the corrugations, are sufficiently flexible to adapt to the shape and width of the wearer's head, but retain their shape, and consequently urge the glasses, once put on, against the head of the wearer. This tends to retain the glasses on the head of the wearer against forces that tend to dislodge those glasses, such as gravity, or inertia when the wearer moves her head. The combination of metal temple and corrugations provide for a comfortable eyeglass which can be worn with confidence.

### BACKGROUND OF THE INVENTION

1. Field of the Invention

The present invention relates to eyeglasses. Specifically, it pertains to eyeglasses with an improved hinge, or temple, that permits the glasses to hug the wearer's head without large springs or other devices, retaining the aesthetic appeal and lightweight character of the glass frames.

2. Background of the Technology

Eyeglasses have been in use for many centuries. Whether the glasses are corrective, designed to provide protection from the sun and irradiation, simply a fashion item, or intended to achieve a combination of these functions, there is constant pressure to make the glasses light in weight, and tightly gripping the wearer, so that they are not easily dislodged or slide off. To this end, a variety of glasses have been developed, and the art has seen the introduction of rimless glasses, and a variety of moving assemblies intended to permit the temple (that portion of the glass that extends from the frame for the lenses to the back of the ear) to fit more snugly to the wearers' head. One such is set forth in U.S. Pat. No. 7,407,282, which provides for a sliding sleeve for the temple. Design patents such as D 574,410 address aesthetic features of such glasses. It remains a goal of those of skill in this art, however, to provide glasses that hug the head of the wearer without including bulky or unattractive elements at or about the temple or frame.

### SUMMARY OF THE INVENTION

An eyeglass is provided without bulky springs or other complicated moving devices by preparing the eyeglasses, or at least the temples thereof, from a lightweight metal. Although any metal can be used consistent with the invention, a particularly preferred material is a metal generally known as a memory allow, or shape memory alloy. Beta Titanium, which is compounded in a variety of alloying metals but is predominately a Ti—Pd alloy, is a suitable memory alloy for this purpose, given its superior light weight and memory retention characteristics. Other metals, memory allows, and other metals, can be used without altering the eyeglasses, or the nature of the invention. Among other preferred alloys is stainless steel. The temple is provided, back from the hinge where it joins the frame, with a corrugation. This lends a certain flexibility to the temple, the combination of the metal alloy and the corrugation or folded shape urging the glasses against the head of the wearer, and resisting dislodging them as the wearer's head is moved, the glasses are adjusted, or any other relative displacement force is applied.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain the features of the invention.

FIG. 1 is a partial front view of the glasses of this invention, illustrating the inventive corrugation of the temple proximal to the hinge connecting the temple to the frame.

FIG. 2 is a partial view expanding that portion of the temple where the corrugation is introduced to improve the shape retention character of the temple, urging it against the wearer's head.

FIG. 3 is a side elevation, demonstrating the placement of the corrugation of the metal temple, along the length of the temple, between the hinge connecting the temple to the frame and the earpiece which rests behind the ear of the wearer.

FIG. 4 is a top plan view of the eyeglasses of the invention, illustrating the flexibility of the temple introduced by the selective use of a corrugation in the temple comprised of a memory alloy, and the forces urging the temple against the wearer's head.

FIG. 5 is an exploded view of that portion of the temple illustrated in FIG. 4 where the corrugation is placed, illustrating the flex introduced by that corrugation.

### DETAILED DESCRIPTION OF THE INVENTION

The inventive eyeglasses, or glasses, that incorporate the features of this patent application, are explained below, in terms of the drawings set forth above. The glasses are not limited in function or character. They may be corrective, sunglasses (providing protection from the sun and/or UV and IR irradiation) or simply fashionable, with clear lenses. The lenses may be made from glass, carbonate or acrylate or other plastic suitable to the purpose. The glasses may be provided with coatings and metal finishes of any type. The frame of the glasses may be complete rims, partial rims, or rimless (where the frames are retained by high strength nylon strands or similar arrangements). The inventive feature of these glasses focuses on the provision of a temple comprised of a metal, bearing corrugations proximal to the hinge connecting the temple to the frame, to enhance the resistance to slippage of the glasses along the head of the wearer under applied force.

The various embodiments will be described in detail with reference to the accompanying drawings. Wherever possible, the same reference numbers will be used throughout the drawings to refer to the same or like parts.

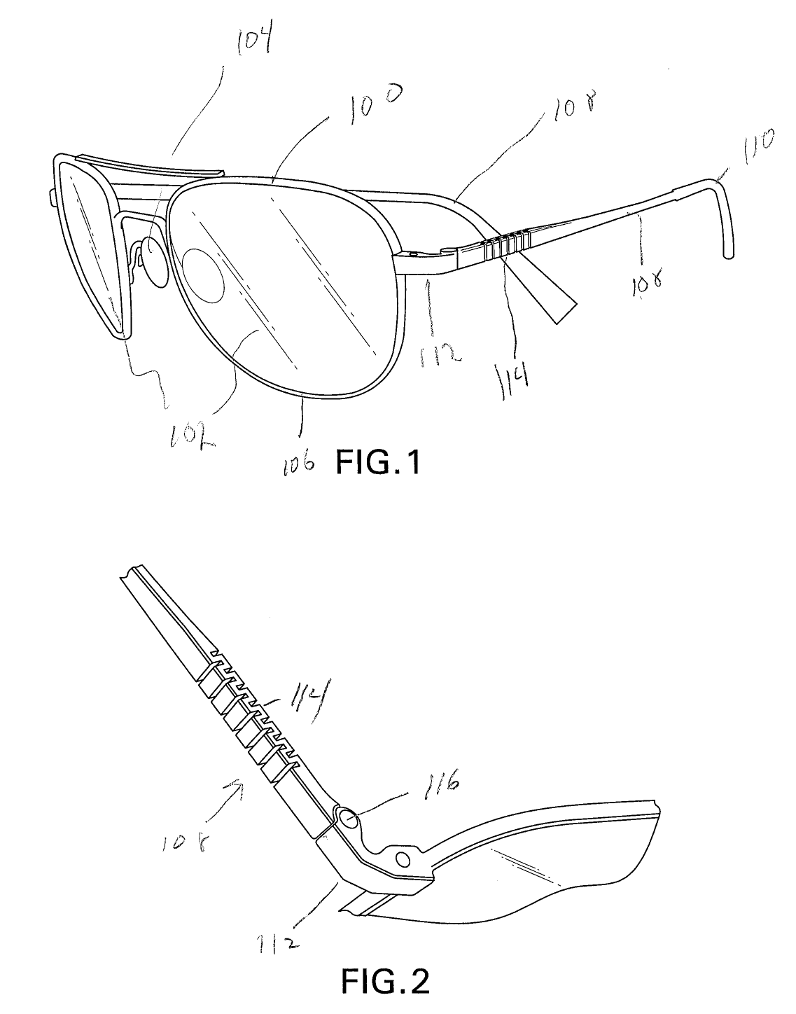

As most clearly shown in FIG. 1, the glasses of this invention include a frame 100, in which are supported two lenses 102. As noted, these lenses may be clear or colored, photochromic or untreated, and comprised of any suitable material. Frame 100 may be of any type and shape provided it includes rests 104 or similar feature t rest on the wearer's nose. In the embodiment shown, frame 100 includes rims 106 for retention of the lenses in the frame, but alternative arrangements are known and consistent with this invention. Extending “rearward” from the frame are temples 108. These extend on each side of the frame, and rest against the head of the wearer in use. The temples are joined to the frames at hinge 112, which may be of conventional design, providing simply a pivot so that the temple may be closed up against the frame when not being worn, and extend out to something close to a 90 degree angle when being placed on the wearer's head. The temples 108 terminate in an earpiece 110, which may be of any suitable shape and design intended to rest on or fit over the exterior of the wearer's ear, fitting behind the auricle of the ear. As shown, less than one third of the way along the temple, a series of corrugations 114 are introduced into the metal of the temple. In practice of the invention, the corrugations can be introduced anywhere along the temple. The function of the corrugations is to provide a certain flexibility to the temple, to urge it against the wearer's head once it has been placed on the wearer, but permit the temple to flex outward while being donned. The location of the corrugations is therefore subject to a wide variation, but is generally more advantageous in the “forward” half of the temple.

The corrugations 114 that are a principal feature of the eyeglasses of this invention are more clearly shown in FIG. 2. As illustrated, a series of folds or ridges are introduced into the temple, which is comprised of a metal of some type, preferably a memory alloy. A preferred memory alloy, because of its shape retention character, light weight, and ease of manufacturing is beta titanium. Stainless steel may also be used. Other memory alloys are also known to those of skill in the art, including Cu—Zn—Al—Ni and similar alloy systems. Other common metal alloys, including a wide variety of heavier nickel based alloys may also be used. For the purposes of this invention, the entire eyeglass, other than the lenses themselves, may be constructed of the metal, or just the temple. The issue is more nearly one of cost and aesthetics than of mode of operation. As shown in FIG. 2, temple 108 joins hinge 112 at pivot pin 116, the shape of the pivot being such as to constrain outward movement of the temple beyond about a 90 degree arc from the frame itself, as is conventional. Proximal to, and about a few centimeters down from the pivot pin 116, corrugations 114, where the metal of the temple is folded in and out of the direction of the temple, are introduced. The number of corrugations is not fixed. The corrugations impart certain flexibility to the temple, in fact acting as a secondary hinge to urge the temple against the head of the wearer. The corrugations, as shown, are placed in the direction of the longitudinal axis of the temple, but they may be orthogonal to that or in other direction. Provided the corrugations provide the requisite flexibility, the number and direction is not important. Representative examples of the invention include a series of 5-10 corrugations in the direction of the longitudinal direction of the temple, placed no more than about two centimeters from the hinge, but these are representative only, and are not a limiting aspect of the invention. They are provided to resist outward movement and slippage along the head, but introduce a degree of comfort and resiliency not experienced in glasses with straight or non-corrugated temples of otherwise similar style.

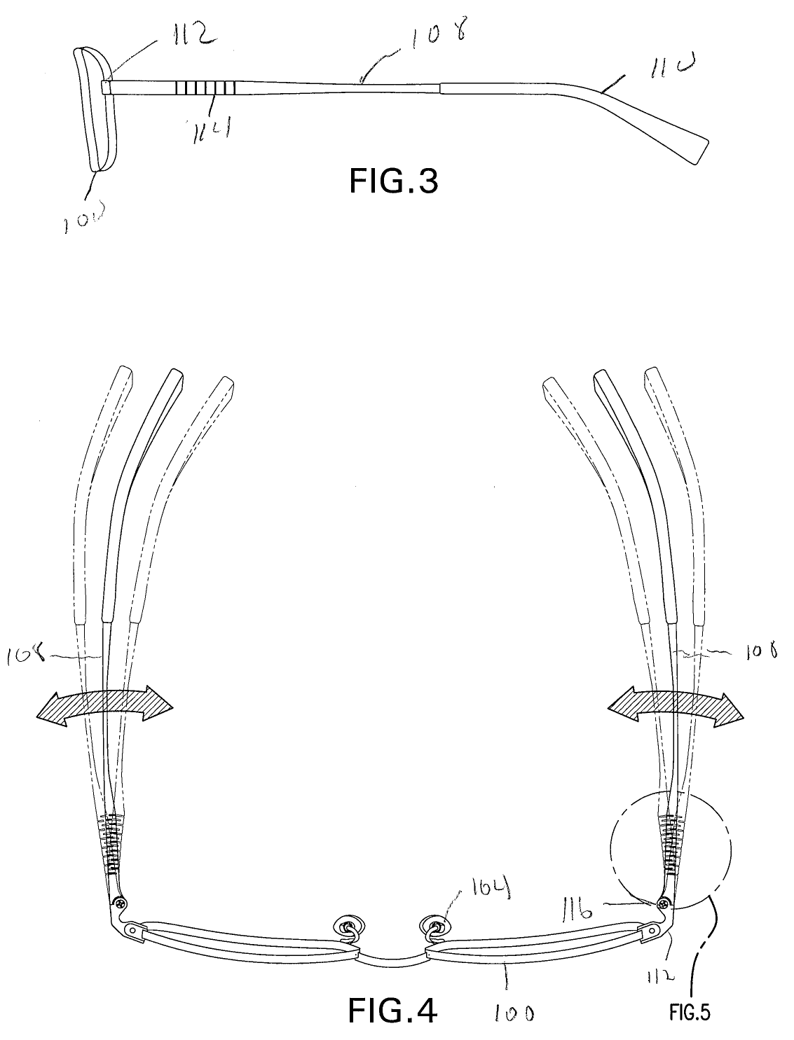

The placement of the corrugations 114 relative the frame 100 and hinge 112 is most clearly seen in FIG. 3, which illustrates the corrugations as proximal too, and just beyond the hinge 112, vis-a-vis the frame 100. As noted, in actual practice, the precise location of the corrugations 114 of the temple is variable, but typically placed within two centimeters of the hinge. By so locating the corrugations 14 in the metal temple, a significant degree of comfort, due to flexibility combined with a good fit that resists slippage, is provided. The temple 108 terminates in earpiece 110, which may either be an integral part of the temple, or applied thereto, as in the nature of a plastic or foam article that fits over the termination of temple 108.

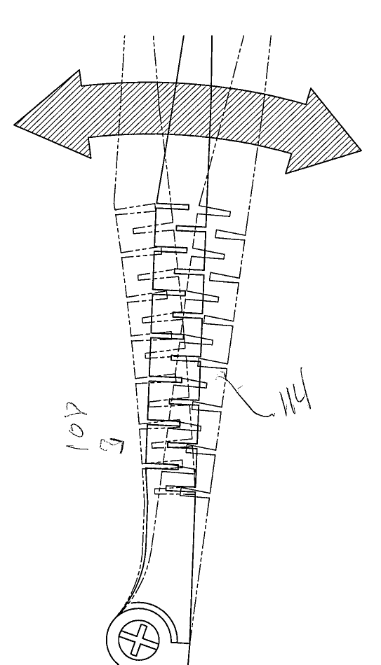

The flexibility of the temple 108 introduced by the corrugations 14 is shown in FIG. 4, which indicates, by arrows, the direction of movement of the temple that is possible, without movement of the frame. Thus, the eyeglasses so constructed expand slightly to accommodate the head of the wearer, in contact therewith, without losing shape. The temples are caused, by the combination of the corrugation and metal, preferably, a memory alloy, against the head of the wearer when in place, resisting forces that tend to dislodge the glasses, including gravity and inertia. It is by this method that the glasses, including frame 100 and rests or pads 104, are placed comfortably on the wearer's head. As shown in FIG. 4, the introduction of the corrugations permits flexion of the temples at a point just beyond the pivot pin 116 of hinge 112.

The relationship between pivot pin 116 and corrugations 114 in temple 108 is most clearly shown in FIG. 5. By placing the corrugations proximal too pivot pin 116, the forehead of the wearer is comfortably accommodated by the glasses, the temple “flexing” at corrugations 114, to adjust to the shape and width of the wearer's head. In an ordinary eyeglass, this would result in distortion of the eyeglasses, bending the temple away from the frame. By combination of the metal corrugations, and the shape of the eyeglasses, and in particular, the temple and its relationship to the frame 110 at hinge 112, is retained. It should be noted that while pivot pin 116 is shown as a conventional cylinder about which the temple rotates, other arrangements that permit approximately 90 degrees of movement are known to those of skill in the art, and provided they can be formed or molded of memory alloy, are equally suitable for use in the invention.

While the present invention has been disclosed with references to certain embodiments, numerous modification, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. An eyeglass for the head of a wearer, comprised of a frame, lenses retained by said frame, and one temple at either terminus of said frame, connected to said frame by a hinge which permits partial rotation of said temples outward from said frame, wherein said temple is comprised of a metal, and said temple is comprised of corrugations along the length of said temple at a location proximal to said hinge.

2. The eyeglass of claim 1, wherein said corrugations are provided distanced from but proximal too a pivot point in said hinge about which said temple rotates through ninety degrees of arc.

3. The eyeglasses of claim 1, wherein said corrugations comprise folds in said metal of said temple, sufficient to confer on said temple sufficient flexibility to comfortably accommodate the head of the wearer while urging said temple against the head of said wearer, such that the glasses resist forces tending to dislodge them from the head of the wearer.

4. The eyeglasses of claim 1, wherein said metal is a memory alloy.

5. The eyeglasses of claim 1, wherein said lenses are selected from the group consisting of corrective lenses, sun protective lenses, photochromic lenses and aesthetically pleasing lenses.

6. The eyeglasses of claim 1, wherein said frame and hinges are comprised of said metal.

7. The eyeglasses of claim 4, wherein said alloy is beta titanium.
